(19) United States
(12) Patent Application Publication
(10) Pub. No.: US 2005/0192521 A1
(43) Pub. Date: Sep. 1, 2005

(54) Method of reducing fatty tissue using lymphatic massage

(76) Inventor: Gloria Hincapie, Miami, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 10/991,008

(22) Filed: Nov. 17, 2004

Related U.S. Application Data
(60) Provisional application No. 60/520,894, filed on Nov. 18, 2003.

(51) Int. Cl. A61H 7/00

(52) U.S. Cl. 601/134; 601/136; 601/137

(57) ABSTRACT

A method for reducing fatty tissue using lymphatic massage is disclosed that includes the steps of evaluating body regions of a patient to determine at least one massage area, massaging in a first session the at least one massage area, the first session massage going in the direction of muscle attachment and the lymphatic system and including an application of a first pressure by balls of fingers of a massage therapist, massaging in a second session the at least one massage area, the second session massage including an application of a second pressure greater than the first pressure, and applying a reducing cream and an almond oil.

### CROSS-REFERENCE TO RELATED APPLICATIONS

This application claims the benefit of U.S. Provisional Application Ser. No. 60/520,894, filed on Nov. 18, 2003, entitled METHOD OF REDUCING FATTY TISSUE USING LYMPHATIC MASSAGE.

### TECHNICAL FIELD OF THE INVENTION

This invention relates to the method and apparatus for treating cellulite-containing areas of the human body and more particularly to a method for applying massage pressure on the areas of the body having cellulite or fatty tissue therein.

### BACKGROUND OF THE INVENTION

Cellulite is a condition of the body that is more commonly found in women than in men. Generally, this condition is found in numerous parts of a woman's body, such as on thighs, hips, stomach and upper arms. Cellulite is typically in the form of bulges and lumpy areas. It is thought that cellulite is a build up of fat, body fluids and toxic residues trapped in the tissues; however, it apparently is not an ordinary fat, as it cannot be lost by diet or exercise. Cellulite afflictions are a stubborn problem causing emotional and psychological distress to many women. Cellulite primarily afflicts the thighs and buttocks but may also be present on the stomach and upper arms. Frequently, cellulite presents an unsightly, lumpy orange-peel appearance. Clinically, cellulite manifests a range of symptoms including thinning of the epidermis, reduction and breakdown of the microvasculature leading to subdermal accumulations of fluids, and subdermal agglomerations of fatty tissue. It has been observed that polymeric proteoglycans are a primary component of these agglomerations.

Previously, in order to liberate these trapped fatty agglomerations and fluids, the local application of enzymes or enzyme containing compositions has been proposed since the enzymes are capable of depolymerizing the proteoglycans. These enzymes include mucopolysaccharidases and, more particularly, hyaluronidase, thiomucase and alpha-mucase.

Moreover, it has also been known to use certain oleosoluble vegetable extracts that, according to a different mechanism, can also act as a slimming agent. U.S. Pat. No. 4,795,638 discloses a thermo slimming cosmetic composition containing an oil-soluble plant extract having slimming action. Representative of these oil-soluble plant extracts are vegetable extracts including, principally, those of climbing ivy (Hedera helix), arnica (Arnica montana), rosemary (Rosmarinus officinalis N), marigold (Calendula officinalis), sage (Salvia officinalis N), ginseng (Panax ginseng), St. Johns-wart (Hypericum perforatum), ruscus (Ruscus aculeatus), meadowsweet (Filipendula ulmaria L) and orthosiphon (Ortosifon stamincus Benth), as well as mixtures of these vegetable extracts.

Notwithstanding such disclosures, there remains a need for improved methods for reducing cellulite in mammalian skin.

### SUMMARY OF THE INVENTION

The present invention eliminates the above-mentioned needs for an improved method of reducing cellulite by providing a method for applying pressure and a kneading action to aid in breaking down the fat cells or nodes so that the fluids present therein can be absorbed into the blood stream and eliminated by the normal waste elimination process.

In accordance with the present invention, there is provided a method for reducing fatty tissue using lymphatic massage that includes the steps of evaluating body regions of a patient to determine at least one massage area, massaging in a first session the at least one massage area, the first session massage going in the direction of muscle attachment and the lymphatic system and including an application of a first pressure by balls of fingers of a massage therapist, massaging in a second session the at least one massage area, the second session massage including an application of a second pressure greater than the first pressure, and applying a reducing cream and an almond oil.

### DETAILED DESCRIPTION OF THE PREFERRED EMBODIMENT

The abdominal cavity contains most of the organs of the digestive system, among which are the stomach, the intestines, the liver. It also holds part of the urogenital organs such as the kidneys and ureter. The abdominal wall is made up of a series of muscles (anterior, major oblique (external), minor oblique (internal) and transverse) that protect it in case of trauma.

The initial focal point of the present invention is the abdominal wall. The technique of the present invention carries out movements in the direction of each of the afore mentioned muscles. These movements are important because in this way each and every one of the intermuscular spaces, where adipose tissue can be stored, can be reached. The movement in the direction of the muscular fiber also ensures that there will be no muscular traumatism resulting from the strong and firm pressure applied in order to optimize results.

It is important to point out that the fat that is removed from the abdomen undergoes a redistribution process towards the main conveyance organs of the human body, such as the circulatory and urological systems, by means of the lymphatic system, which transports lymph, a viscous fluid that usually moves macromolecules such as fat that cannot be transported through the blood stream due to their large size.

After performing a reducing massage of the present invention, pressure is applied to the lymph from the central chyliferous vessels toward the abdominal lymphatic vessels by means of rhythmic contractions induced by the pressure exerted from the abdominal wall with each therapeutic movement of the technique of the present invention (further detailed below). The fat is transported in chylomicrons, which is a lipoprotein that transports fat after a large meal or in cases of persons who have localized areas of abdominal fat. The chylomicrons move the fat through the thoracic conveyor, which in turn empties its content into the blood stream. As a result, fat reaches the kidneys, where it is expelled through the renal processes of filtration, secretion and excretion.

Thus, the process of the present invention allows the fat and other toxins that generate physical and esthetic harm to the recipient to be eliminated through the urinary tract. Gradually, as the therapeutic sessions continue, as well as eliminating toxins and fat, molding of the masculine and feminine figures can be accomplished. With each session in which fat is removed from localized areas, the process, which begins at the level of the abdominal wall, induces the body itself to take on a form that is more harmonious with its natural shape.

In accordance with the preferred embodiment of the present invention, a patient will provide personal information, such as illnesses or other conditions that may interfere with treatment, to a massage therapist for evaluation. Upon evaluation of the patient's body regions by the massage therapist, the massage therapist identifies at least one massage area. If more than one massage area is identified, treatment is prioritized to be given to the at least one massage area requiring the most therapy. All massages are performed on localized areas. The pressure applied to each localized area increases from session to session.

This technique will be repeated in said massage area as many sessions as needed. Massage will be made in the direction of the flow of the lymphatic system. In each session the massage therapist will measure the degree of fixation of the fatty tissue and determine the amount of pressure to be applied to such area.

Traditional massages systems consisted in the application of different types of movements and the manipulation of body tissues aimed at relaxing and relieving body ailments.

The technique described in this application consists of the systematic application of one-way strokes following the flow of the lymphatic systems aimed at removing adipose and fatty tissue through the lymphatic system. Strokes and movements will change depending on the massage area.

The technique consists of carrying out a procedure directed towards the adipose tissue from the depths of the system, even removing intramuscular fat. The movements must always be in the direction of the muscles, moving the fat toward the lymphatic system in order that it may be eliminated trough the urinary tract and other ways of elimination. For this reason, it is important to increase water intake so that the body can detoxify and carry out the cleansing process. This technique also promotes the peristaltic movements of the colon, which are of great importance in the organism's decongestion process.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following appended claims.

1. A method for reducing fatty tissue using lymphatic massage comprising the steps of:
evaluating body regions of a patient to determine at least one massage area;
massaging in a first session said at least one massage area, said first session massage going in the direction of muscle attachment and the lymphatic system and including an application of a first pressure by balls of fingers of a massage therapist;
massaging in a second session said at least one massage area, said second session massage including an application of a second pressure greater than said first pressure; and
applying a reducing cream and an almond oil.
